(19) United States
(12) Patent Application Publication
(10) Pub. No.: US 2025/0111624 A1
(43) Pub. Date: Apr. 3, 2025

(54) Creative Control for Environment Lighting Effects in Video Presentation

(71) Applicant: Apple Inc., Cupertino, CA (US)

(72) Inventors: Marshall W. Huss, Santa Clara, CA (US); Derek E. Bowen, Santa Clara, CA (US); Suresh Koppisetty, San Jose, CA (US)

(21) Appl. No.: 18/884,298

(22) Filed: Sep. 13, 2024

Related U.S. Application Data
(60) Provisional application No. 63/541,127, filed on Sep. 28, 2023.

(51) Int. Cl. G06T 19/00

(52) U.S. Cl. CPC G06T 19/006

(57) ABSTRACT

Various implementations present video content along with time-synchronized environment lighting effects (e.g., light-spill). The environment lighting effects are based on obtaining a stored environment parameter specifying the effects for different times during the video content (e.g., effects stored as a track/metadata of the content itself or effects stored in a separate lookup table). A content creator is enabled to specify, for their content item, the light-spill (color, intensity, saturation, brightness/nits, opacity, etc.) or other environment lighting effects, such as making a sun effect brighter using HDR. The ability to specify such effects may give those content creators and editors more control over the content-viewing experience. Predefined/stored effects may also facilitate using effects in the case of real-time streaming in which on-the-fly, automatic content-based effect determinations may be infeasible.

### CROSS-REFERENCE TO RELATED APPLICATIONS

This application claims the benefit of U.S. Provisional Application Ser. No. 63/541,127 filed Sep. 28, 2023, which is incorporated herein in its entirety.

### TECHNICAL FIELD

The present disclosure generally relates to systems, methods, and devices that present video content items (e.g., movies, TV shows, etc.) on electronic devices along with additional environment lighting effects.

### BACKGROUND

Existing techniques for providing environment lighting around video content items may be limited. A user may view a video content item on a stand-alone television set within their living room or view a video content item on a virtual screen presented within, for example, an extended reality (XR) environment presented by a head-mounted device (HMD). While lighting effects can be added to such environments and can enhance the viewing experience, existing systems may not adequately enable creative control of such environment lighting effects, enable such effects in live and streaming circumstances, or otherwise provide for such effects in an efficient, effective, or otherwise desirable manner.

### SUMMARY

Various implementations disclosed herein include devices, systems, and methods that present video content items (e.g., movies, TV shows, home-made videos, etc.) along with time-synchronized environment lighting effects (e.g., light-spill). The environment lighting effects are provided based on obtaining a stored environment parameter specifying the effects for different times during the video content (e.g., effects stored as a track/metadata of the content itself or effects stored in a separate lookup table). A content creator is enabled to specify, for their content item, the light-spill (color, intensity, saturation, brightness/nits, opacity, etc.) or other environment lighting effects, such as making a sun effect brighter using HDR. The stored environment parameter(s) may specify spatial attributes of the effects. For example, a parameter may specify upon which side (e.g., to the left, on top of, etc.) of a video content item display window (e.g., virtual screen) that a particular effect will be displayed. As another example, the parameter may specify the size or scope of the effect (e.g., specifying how many pixels away from the content item display window the effect will extend). As another example, the parameter may specify the locations of different color effects (e.g., providing red light spill on the left side of the content display window, blue above, green below, etc.). The predefined/stored effects can be specified by content creators/editors. The ability to specify such effects may give those creators/editors more control over the content-viewing experience. Predefined/stored effects may also facilitate using effects in the case of real-time streaming in which on-the-fly, automatic content-based lighting effect determinations may be infeasible.

In some implementations, an electronic device has a processor (e.g., one or more processors) that executes instructions stored in a non-transitory computer-readable medium to perform a method. The method performs one or more steps or processes. In some implementations, the method involves obtaining environment parameter data associated with a video content item. The environmental parameter data may be obtained from a source that stores the environment parameter data for access to control presentation of playback environments during multiple playback instances of the video content item. As non-limiting examples, the source of the environment parameter effect data (e.g., specifying lighting effects for a video content item) may be the file that contains the video content item or a separate database lookup table.

The method further involves determining environment lighting effects corresponding to a plurality of time segments (e.g., frames) of the video content item. The environment lighting effects are determined based on the environment parameter data.

The method further involves presenting the video content item in a viewing environment, wherein the viewing environment is modified based on the environment lighting effects in synchronization with presentation of the plurality of time segments of the video content item. In one example, each frame of a multi-frame video content item is presented within a viewing environment that is modified by a corresponding effect (e.g., the effect associated with the respective video frame).

In some implementations, the video content item is presented within an XR environment and the effects may be applied to the XR environment, e.g., around a window or virtual screen upon which the video content item is presented. In some implementations, the video content item and environment lighting effects are presented in pass-through video. The effect may be used to alter a view of live pass-through video with a video content item displayed on a virtual screen with a light-spill effect applied around the virtual screen. In the pass-through implementations, the effect may be added by changing a display attribute of the pass-through content around the object. In some implementations, a light-spill effect may be added by modifying a display attribute of a portion of the live pass-through video content (e.g., a wall, a floor, furniture, etc.) located around or adjacent to the video content item. For example, a display attribute may include, inter alia, a color attribute, a tinting attribute, a dimming attribute, a light glow attribute, etc.

In some implementations, a hardware blend architecture (e.g., blend circuitry) implemented process may be used to blend pass-through video frames of the live pass-through video content with content of the virtual object. The blending process may be further configured to implement a lighting (e.g., light-spill) effect. In some implementations, the blending process may include a tinting/color mixing process using hardware-based logical pixel operations. The blending process may include any type of blending technique.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2B illustrate views of an XR environment provided by the devices of FIG. 1, in accordance with some implementations.

FIG. 3 is a system flow diagram of an exemplary system that displays a video content item along with environment effects, in accordance with some implementations.

FIG. 4 is a system flow diagram of another exemplary system that displays a video content item along with environment effects, in accordance with some implementations.

FIG. 5 is a flowchart illustrating an exemplary method that displays video content items with environment effects, in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

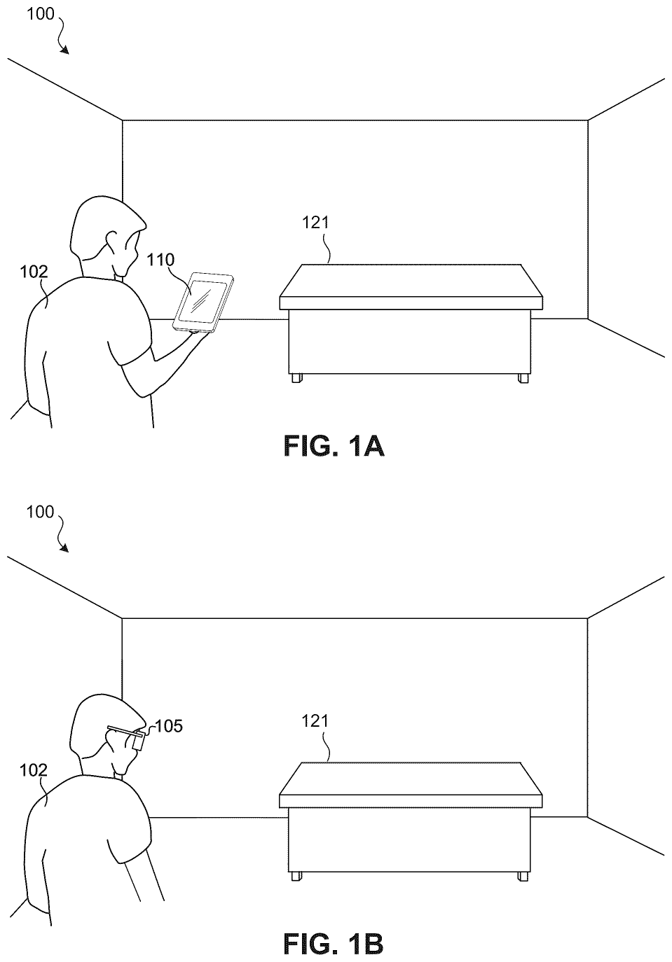

FIGS. 1A-B illustrate exemplary electronic devices 105 and 110 operating in a physical environment 100. In the example of FIGS. 1A-B, the physical environment 100 is a room with a desk 121. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may be a 3D environment that is generated based on camera images and/or depth camera images of the physical environment 100 as well as a representation of user 102 based on camera images and/or depth camera images of the user 102. Such an XR environment may include virtual content (e.g., one or more video content items) that is positioned at 3D locations relative to a 3D coordinate system associated with the XR environment, which may correspond to a 3D coordinate system of the physical environment 100. In one example, an XR environment includes a video content item displayed within an entirely virtual surrounding environment. In one example, an XR environment includes a video content item displayed within an entirely real surrounding environment (e.g., via pass-through or see-through portions of an HMD). In one example, an XR environment includes a video content item displayed within a surrounding environment that includes both real and virtual elements. The appearance of the surrounding environment may be modified to present light spill or other environment lighting effects.

In some implementations, an XR environment is presented using pass-through video that depicts a physical environment (e.g., physical environment 100). Pass-through video, for example, may be provided based on receiving and presenting images from an image sensor (e.g., outward-facing cameras) of a device (e.g., device 105 or device 110). In some implementations, a video content item is presented with the pass-through video content and an environment lighting effect (e.g., a light-spill effect) is generated around or adjacent to the video content item or otherwise such that the effect is projected over depictions of one or more real-world objects of the physical environment (e.g., a wall, a floor, furniture, etc.).

The environment lighting effect may have been specified by the content creator (e.g., a movie's producer) for a particular video content item, e.g., specifying for the lighting effects to be provided for individual frames of the video content item The environment lighting effect may have been created when a video content item was created or edited (e.g., prior to distribution for use) and may be associated with the video content item to guide playback of the video content item. In some implementations, a video content item has a format or use restrictions such that video content playing engines ensure usage of any associated environment lighting effects.

An environment lighting effect may be specified in environment parameter data associated with a video content item. The environmental parameter data may be obtained from a source that stores the environment parameter data for access to control presentation of playback or other presentation environments during multiple instances of presenting the video content item. As non-limiting examples, the source may be a file that contains the video content item or a separate database lookup table. A movie (or other video content item) may be distributed as files or computer-readable media that contains both the video content item and the environment lighting parameters associated therewith and content playing devices and applications may be configured to play these different instances of the video content item using the distributed parameters. Similarly, a movie (or other video content item) may be distributed as files or computer-readable media that contains both the video content item and unique identifier that can be used to obtain the parameters from a separate source (e.g., an internet-accessible database).

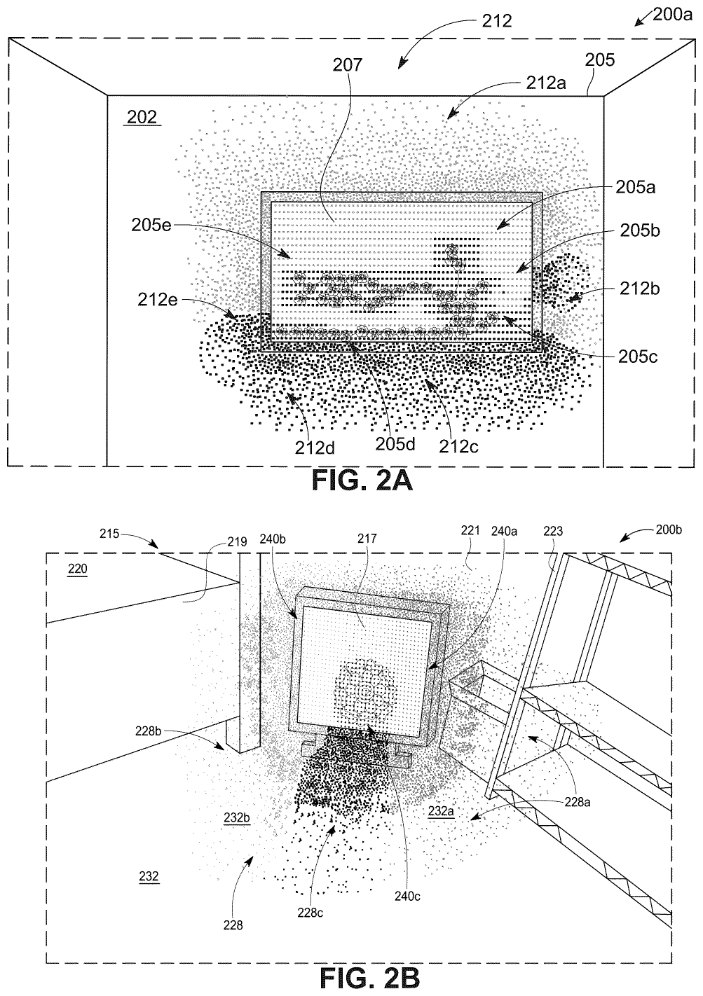

FIG. 2A illustrates a view 200a of an exemplary XR environment 202 provided by a device (e.g., device 105 and/or 110 of FIG. 1). XR environment 202 includes (live) pass-through video 205 of a physical environment (e.g., a wall as illustrated in FIG. 2A) and a video content item 207 (e.g., a Movie, TV show, etc.) presented within a 2D display window. View 200a illustrates a light-spill effect 212 (e.g., changes in the appearance of the nearby environment that mimics the appearance of light emanating from the video content item and affecting the appearance of nearby (or far away) objects in the environment). The light-spill effect may be based on lighting attributes, such as color, tint, etc. associated with lighting of the video content item 207. The light-spill effect may be presented adjacent to, over, under, or around the video content item 207. The light-spill effect 212 is generated based on an environment lighting parameter associated with the video content item 207. (e.g., the parameter may specify an attribute of the light-spill effect). View 200a may be a view presented to a user wearing an HMD (e.g., device 105) in their living room (e.g., the physical environment) watching a virtual screen (e.g., virtual television screen or a display that is depicted on a wall within the living room as illustrated in FIG. 2A).

Light-spill effect 212 includes light-spill effect portions 212a-212e. Light-spill effect portion 212a comprises a tinting color mix associated with a color of portion 205a (e.g., comprising multiple colors) of a (active lighted) screen of video content item 207. Light-spill effect portion 212b comprises a tinting color mix associated with a color mix of portions 205b and 205c (flowers) of the screen video content item 207. Light-spill effect portion 212c comprises a tinting color mix associated with a color mix of portions 205c and 205d of the screen of video content item 207. Light-spill effect portion 212d comprises a tinting color mix associated with a color mix of portions 205d and 205e of the screen video content item 207. Light-spill effect portion 212e comprises a tinting color mix associated with a color of portion 205e of the screen of video content item 207. While a user is immersed with in the XR environment (via an HMD), environment lighting effects (e.g., light-spill effect) associated with content on a virtual screen (e.g., video content item 207) are presented to the user. The light-spill (or other environment lighting effect) may be presented in a realistic manner, e.g., presenting virtual light-spill that is similar to the light-spill that a real TV, etc. might provide.

In some implementations, light-spill effect 212 may be enabled with respect to pass-through video 205 content via usage of a reconstructed geometric mesh (e.g., providing surface normal or other environment surface information that may be used to provide or enhance lighting effects).

In some implementations, the light-spill effect 212 (e.g., tinting/color mix) is generated (e.g., using hardware-based logical pixel operations) in response to capturing frames of the pass-through video 205 (of a physical environment) via outward-facing cameras (of an HMD) connected to a display (of the HMD) via a dedicated hardware path of an application specific integrated circuit (ASIC). In some implementations, light detection and ranging information may be captured and processed.

A processor may be configured to process frames of the pass-through video 205 at a relatively high frames per second (FPS) rate such as, e.g., a frame rate greater than 60 FPS. In some implementations, the ASIC retrieves each frame (of the pass-through video 205) from the outward-facing cameras and blends each pass-through frame (of the pass-through video 205) with video content frame-specific lighting effects. The blending process may include an alpha blending process for combining each of the frames of the pass-through video (e.g., background content) with the frame-specific virtual content to create an appearance of transparency with respect to portions of the pass-through video. In some implementations, alpha-blend values associated with the pass-through video 205 in areas corresponding to the video content item may be adjusted.

In some implementations, using a hardware-based process to blend pass-through frames with a video content item 207 to implement the light-spill effect 212 may enable a process for adding the video content item 207 and light-spill effect 212 quickly, e.g., in real-time live views, and/or using fewer resources than might otherwise be required to 3D model virtual light rays emitted from the video content item 207.

As a result of the blending process, an augmented pass-through video view comprising real and virtual content (e.g., video content and effects) is generated for presentation to a user. A portion of each of the frames of the pass-through video may be altered to generate a light-spill effect (viewable within the augmented pass-through video view as illustrated in FIG. 2A) based on at least one effect determined from the frame-specific video content item 207, e.g., from environment parameter data associated with each frame or scene.

Altering a portion of each of the frames of the pass-through video may be executed via operation of a processor (e.g., an ASIC) and may include, but is not limited to including, tinting, dimming, or changing a brightness of a respective portion of each of the frames. In some implementations, the altering process may include performing a hardware-implemented logic operation via an ASIC.

FIG. 2B illustrates a view 200b of an exemplary XR environment 220 provided by a device (e.g., device 105 and/or 110 of FIG. 1). XR environment 220 includes (live) pass-through video 221 of a physical environment (e.g., a representation of a room 215 as illustrated in FIG. 2B) and a virtual representation of a video content item 217 (e.g., a virtual television providing a view of a video stream or a picture such as a static photo). Representation of room 215 comprises a representation of a bed 219, a representation of a shelf 223 and a representation of a floor 232.

View 200b illustrates a light-spill effect 228 (associated with video content item 217) presented adjacent to and around portions the video content item 217. View 200b may be a view presented to a user wearing an HMD (e.g., device 105) in their living room (e.g., room 215) watching a virtual screen (e.g., virtual television screen that is depicted within room 215 as illustrated in FIG. 2B).

Light-spill effect 228 includes light-spill effect portions 228a-228b. Light-spill effect portion 228a comprises a tinting color mix associated with a color of portion 240a (e.g., comprising multiple colors) of video content item 217. Light-spill effect portion 228a represents a pattern that is based upon an appearance of portion 240a of video content item 217. Light-spill effect portion 228a affects the appearance of the representation of the shelving unit 223 and the representation of the portion 232a of floor 232. Light-spill effect portion 228b comprises a tinting color mix associated with a color of portion 240b (e.g., comprising multiple colors) of video content item 217. Light-spill effect portion 228b represents a pattern that is based upon the appearance of video content item 217. Light-spill effect portion 228b affects the appearance of the representation of bed 219 and the representation of the portion 232b of floor 232.

In some implementations, the light-spill effect 228 (e.g., tinting/color mixing using hardware-based logical pixel operations) is generated in response to capturing frames of the pass-through video 221 (of a physical environment) via outward-facing cameras (of an HMD) connected to a display (of the HMD) via a dedicated hardware path of an application specific integrated circuit (ASIC) as described with respect to FIG. 2A, supra.

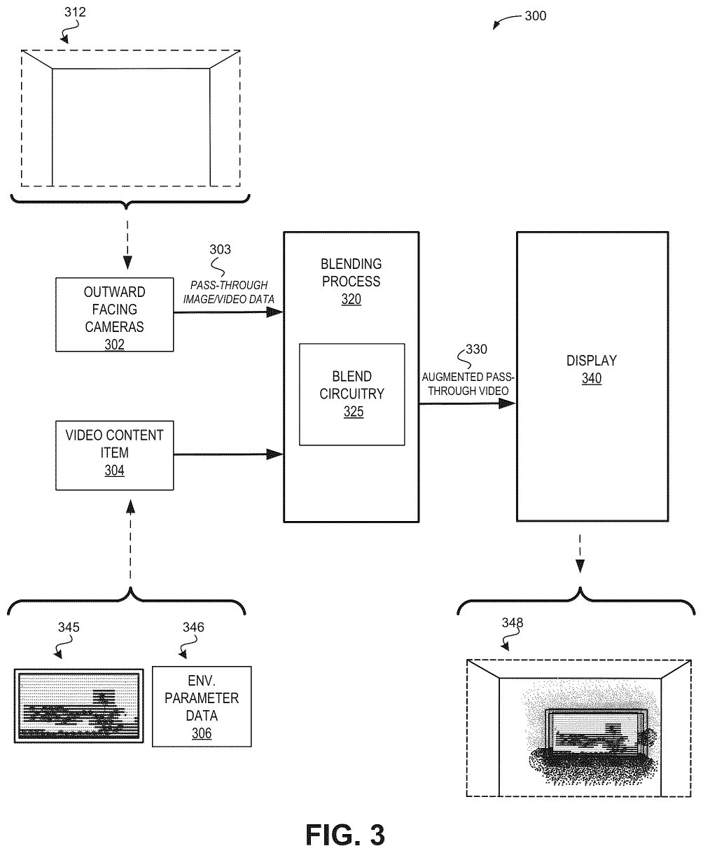

FIG. 3 is a system flow diagram of an exemplary process 300 that displays a video content item in an environment along with environment effects. In some implementations, the process 300 is performed on a device (e.g., device 105 or 110), such as a mobile device, head-mounted device (HMD), desktop, laptop, or server device. In some implementations, the process 300 may be performed by processing logic, including hardware, firmware, software, or a combination thereof. In some implementations, the process 300 is performed on a processor executing code stored in a non-transitory computer-readable medium (e.g., a memory).

The process 300 acquires frames of pass-through image/video data 303 (via outward facing cameras 302), the frames depicting physical environment 312. The process 300 also obtains video content item 304. In this example, the video content item 304 includes frames of content 345 (e.g., visual frames and synchronized audio frames) and environment parameters data 346 (e.g., frames of environment parameters corresponding to the visual/audio frames).

The video content item 304 may be a file comprising data that specifies 2D content for each of multiple frames. Each of these video frames may be positioned on a 2D surface within a 3D coordinate system corresponding to the physical environment 312. Doing so positions the video content item 304 relative to the physical environment 312 for purposes of providing views of an XR environment in which the video content item 304 appears to be displayed on a virtual screen within the physical environment 312, e.g., the movie, TV show, etc. appears to be playing on a virtual screen within the physical environment in the XR view. In the XR environment, the video content item 304 may have a 2D or 3D shape.

In some implementations, virtual content such as a virtual television with the video content item 304 is given a fixed position within the 3D XR environment (e.g., providing world-locked video content item viewing window), e.g., so that the virtual television will appear to the user to remain at a fixed position 3 feet in front of the corner of the user's room, even as the user moves about and views the room from different viewpoints. In some implementations, the video content item 304 is positioned such as a virtual television is provided at a fixed position relative to the user (e.g., user-locked virtual content), e.g., so that the virtual television will appear to the user remain a fixed distance in front of the user, even as the user moves about and views the room from different viewpoints. Acquiring the video content item 304 may involve determining a 3D position of the video content item 304 and determining a partial image (e.g., a partial 2D frame of only the video content item 304) from a viewpoint within the 3D environment. Such a viewpoint may be based on the device's current position within the physical environment corresponding to the 3D environment.

The process 300 combines the pass-through image/video data 303 and the video content item 304 to generate views of an XR environment that includes the pass-through image/video data 303 and the video content item 304 represented in a view on display 340.

In some implementations, the pass-through image/video data 303, the video portion of the video content item 304, and an environment lighting effect (e.g., an effect defined by the environment parameter data 306) are combined to provide a view 348 of the video portion of video content item 304 within a depiction of the physical environment 312 and with a defined environment lighting effect applied. The combination of these elements may be achieved, in some implementations, via a dedicated hardware path, e.g., implemented via blending process 320. Blending process 320 may be implemented by a processor, e.g., a dedicated processor, configured to execute blend circuitry 325.

In some implementations, generating an environment lighting effect involves identifying a pixel region (e.g., a portion of the rectangular display area/pixel grid) that corresponds to a video content item (e.g., where the virtual screen is). Areas of the pass-through video around or otherwise near the virtual object pixel region may be identified, e.g., identifying all pass-through pixels within a specified distance (e.g., X number of pixels) of the pixel region. These identified areas of the pass-through may then be altered to provide an environment lighting effect, such as a light-spill effect. In some implementations, the effect varies or otherwise depends upon the distance (e.g., in pixel space) from the video content item pixel region. For example, pass-through video pixels that are nearest the region may be altered more (e.g., showing brighter light-spill) than pixels further from the region. In one example, pixel brightness is reduced (e.g., using a linear or other function) as distance from the region increases.

A portion (e.g., some or all) of each of the frames of the pass-through video may be altered to generate the effect (viewable within the view 348). Altering a portion of each of the frames of the pass-through image/video data 303 may be executed via operation of the blending process 320 and may include tinting, dimming, or changing a brightness, as examples, of a respective portion of each of the frames. In some implementations, the altering process may include performing a hardware-implemented logic operation via the blending process 320 (e.g., via an ASIC).

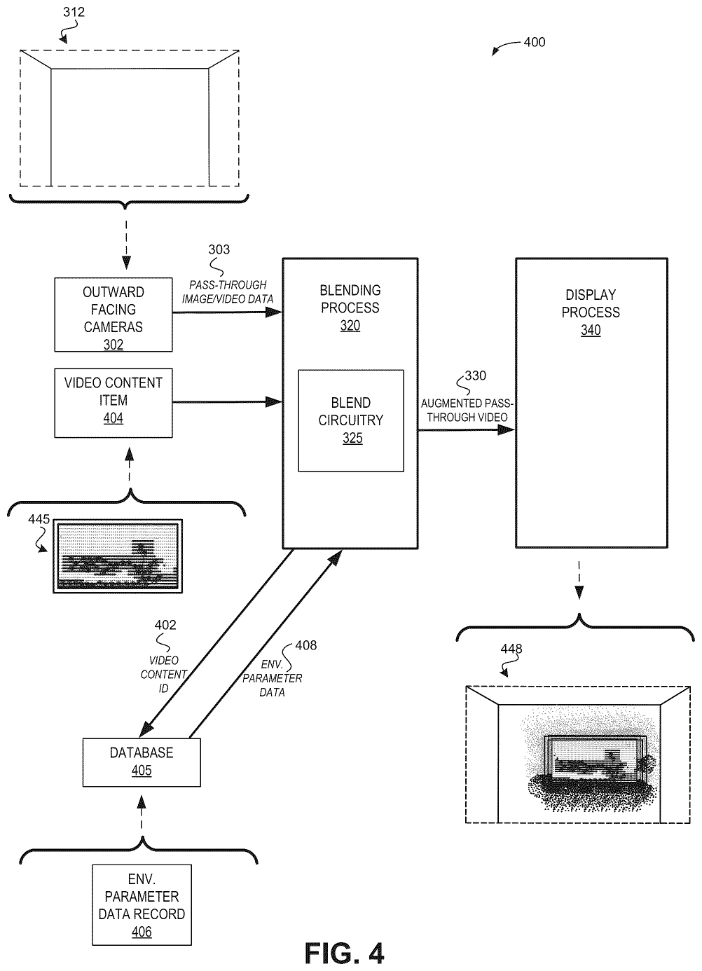

FIG. 4 is a system flow diagram of another exemplary process 400 that displays a video content item along in an environment along with environment effects. In some implementations, the process 400 is performed on a device (e.g., device 105 or 110), such as a mobile device, head-mounted device (HMD), desktop, laptop, or server device. In some implementations, the process 400 may be performed by processing logic, including hardware, firmware, software, or a combination thereof. In some implementations, the process 400 is performed on a processor executing code stored in a non-transitory computer-readable medium (e.g., a memory).

Similar to process 300 (FIG. 3), the process 400 acquires frames of pass-through image/video data 303 (via outward facing cameras 302), the frames depicting physical environment 312. The process 400 also obtains video content item 404. In this example, the video content item includes frames of content 445 (e.g., visual frames and synchronized audio frames).

The process 400 also obtains environment lighting parameters 408. In this example, the process 400 uses a unique identifier associated with the video content item 404 (e.g., video content ID 402, which may be a unique number, name, code, etc. stored in metadata of the video content item 404) to send a request to database 405, which uses the unique identifier to lookup or otherwise retrieve an associated environment parameter data record 406 and return environment lighting parameter data 408. The environment lighting parameters data 408 may include frame-specific data (e.g., frames of environment parameters corresponding the visual/audio frames of the video content item 404).

The video content item 404 may be a file comprising data that specifies 2D content for each of multiple frames. Each of these video frames may be positioned on a 2D surface within a 3D coordinate system corresponding to the physical environment 312. Doing so positions the video content item 404 relative to the physical environment 312 for purposes of providing views of an XR environment in which the video content item 404 appears to be displayed on a virtual screen within the physical environment 312, e.g., the movie, TV show, etc. appears to be playing on a virtual screen within the physical environment in the XR view. In the XR environment, the video content item 404 may have a 2D or 3D shape. Acquiring the video content item 404 may involve determining a 3D position of the video content item 404 and determining a partial image (e.g., a partial 2D frame of only the video content item 404) from a viewpoint within the 3D environment. Such a viewpoint may be based on the device's current position within the physical environment corresponding to the 3D environment.

The process 400 combines the pass-through image/video data 303 and the video content item 404 to generate views of an XR environment that includes the pass-through image/video data 303 and the video content item 404 represented in view on display 340.

In some implementations, the pass-through image/video data 303, a video portion of the video content item 304, and an environment lighting effect (e.g., an effect defined by the environment parameter data 408) are combined to provide a view 448 of the video portion of video content item 304 within a depiction of the physical environment 312 and with a defined environment lighting effect applied. The combination of these elements may be achieved via a dedicated hardware path, e.g., implemented via blending process 320. Blending process 320 may be implemented by a processor, e.g., a dedicated processor, configured to execute blend circuitry 325.

In some implementations, generating an environment lighting effect involves identifying a pixel region (e.g., a portion of the rectangular display area/pixel grid) that corresponds to a video content item (e.g., where the virtual screen is). Areas of the pass-through video around or otherwise near the virtual object pixel region may be identified, e.g., identifying all pass-through pixels within a specified distance (e.g., X number of pixels) of the pixel region. These identified areas of the pass-through may then be altered to provide an environment lighting effect, such as a light-spill effect. In some implementations, the effect varies or otherwise depends upon the distance (e.g., in pixel space) from the video content item pixel region. For example, pass-through video pixels that are nearest the region may be altered more (e.g., showing brighter light-spill) than pixels further from the region. In one example, pixel brightness is reduced (e.g., using a linear or other function) as distance from the region increases.

A portion (e.g., some or all) of each of the frames of the pass-through video may be altered to generate the effect (viewable within the view 448). Altering a portion of each of the frames of the pass-through image/video data 303 may be executed via operation of the blending process 320 and may include tinting, dimming, or changing a brightness, as examples, of a respective portion of each of the frames. In some implementations, the altering process may include performing a hardware-implemented logic operation via the blending process 320 (e.g., via an ASIC).

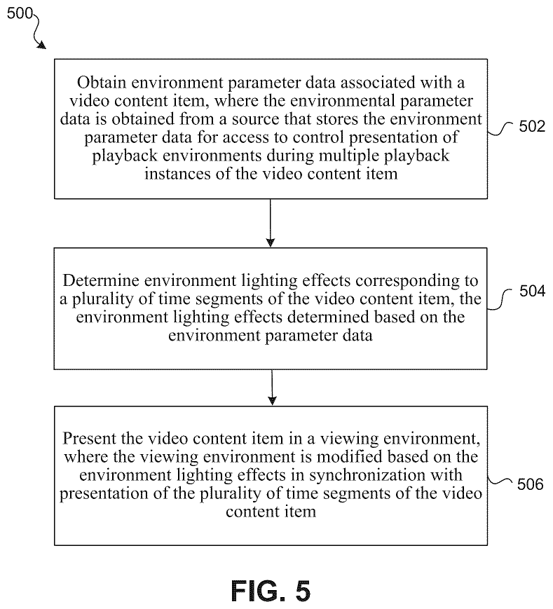

FIG. 5 is a flowchart illustrating an exemplary method that displays video content items with environment effects. In some implementations, the method 500 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

At block 502, the method 500 involves obtaining environment parameter data associated with a video content item, where the environmental parameter data is obtained from a source that stores the environment parameter data for access to control presentation of playback environments during multiple playback instances of the video content item. In one example, the source is a file containing the video content item, for example, where the file comprises a video track, an audio track, and an environment parameter track. In one example, the source is a database (e.g., separate from the file containing the video content item), where the environment parameter data associated with the video content item is obtained by obtaining one or more records from the database using a unique identifier associated with the video content item.

The environment parameter data may comprise data for synchronizing the environment lighting effects with the plurality of time segments. For example, the environment parameter data may provide one or more tracks that identify parameter values along a timeline associated with the playback timeline of a video content item.

At block 504, the method 500 further involves determining environment lighting effects corresponding to a plurality of time segments (e.g., frames) of the video content item, the environment lighting effects determined based on the environment parameter data.

At block 506, the method 500 further involves presenting the video content item in a viewing environment, where the viewing environment is modified based on the environment lighting effects in synchronization with presentation of the plurality of time segments of the video content item. Each frame may be presented within the viewing environment as modified by a corresponding effect.

In some implementations, the effect may be provided in pass-through video. The effect may alter a view of live pass-through video with a virtual object (e.g., a virtual movie screen, TV, etc.) and a light-spill effect around the virtual object. In the pass-through example, the effect may be added by changing a display attribute of the pass-through content around the object (e.g., tinting, dimming, glowing some of the pass-through content).

In some implementations, presenting the video content item comprises presenting the video content item within a view of an XR environment, where the video content item is presented at a 3D position within the XR environment and the environment lighting effects alter the appearance of content in the view separate from the video content item.

In some implementations, the environment lighting effects comprise tint, dimming, or glow effects applied to at least a portion of the viewing environment. In some implementations, the environment parameter data specifies color, intensity, saturation, brightness, or opacity associated with the light-spill effects.

In some implementations, the environment lighting effects comprise light-spill effects. The environment parameter data may specify attributes of the light-spill effects. The environment parameter data may specify a spatial display attribute of the light-spill effects relative to a position at which the video content item is displayed in a view. As examples, the data may specify upon which side to position an effect (left side of a content window, above the content window, etc.), how big an effect should be (e.g., how many pixels does the effect extend), spatial color locations (e.g., specifying the left side to be red, the right side to be green, etc.).)

The environment parameter data is generated based on input provided by a creator or editor of the video content item. For example, a movie producer may embed metadata in a movie when the movie is created that specifies lighting effects for one or more specific frames or scenes of the movie.

In some implementations, a content creator desires to provide environment lighting effects with particular characteristics. For example, content may be associated with trademarks or brands that utilize particular shades of color, and a content producer may desire to use lighting effects that utilize that particular shade of color. For example, a superhero brand may use a particular shade of red and a particular shade of blue in its logo and produce movies and TV shows with specified environment lighting effects that use those particular shades of red and blue. Such shade matching may only be possible with explicitly defined and specified processes, e.g., automatic estimation of lighting effects based on content analysis may produce off shades rather than exact shade matches.

In some implementations, a content creator may specify a lighting effect to produce a particular reaction by the audience, e.g., drawing the viewers' attention to a particular side of the environment off of the video content itself. In some cases, the lighting effects (e.g., light-spill colors, etc.) are specified without regard to what is in the content, but rather are based on other considerations, e.g., to set a particular mood or ambiance. In some implementations, the lighting effects are reflections of portions of a video content, e.g., providing reflections of the villain in a horror movie. In some implementations, the lighting effects are configured to temporarily draw the attention away from the video content so that surprises in the content will be experienced in a more surprising way.

In some implementations, lighting effects are defined in terms of a 3D viewing environment, e.g., appearing to be a specified distance from the viewing screen (upon which the video content is displayed) within the 3D environment. In some implementations, the lighting effects comprise virtual objects (e.g., virtual torches, candles, chandeliers, lamps, etc.) that change over the course of the video content item's presentation, e.g., dimming the candles along the side of the room during a suspenseful scene in a movie.

In some implementations, lighting effects are defined in terms of the user's field of view, e.g., occupying 20% of the user's field of view in one scene and then changing to occupy 70% of the user's field of view in the next scene.

In some implementations, environment parameters specify non-lighting aspects of a viewing environment. In some implementations, the parameters specify the entire viewing environment. For example, a content creator of superhero movie series may specify that the movies of the series are all to be viewed in particular lighting conditions, in a particular environment (e.g., in a particular virtual theater), or using a particular theme (e.g., in a mountain-themed environment versus a city-themed environment). In some implementations, environment parameters are specified specifically (e.g., specifying the specific colors, size, or other attributes of particular lighting effects). In some implementations, environment parameters are specified more generally (e.g., specifying general themes, moods, atmospheres, types of effects, etc.). Environment effects can be varied over time, for example, as a gradually brightening or darkening room or a room in which the room color changes incrementally over time.

In some implementations, a viewing environment is driven entirely by the video content item's environment parameters. For example, a movie about intergalactic battles may be presented in a virtual environment depicting a space-based setting (e.g., with the movie presented on a virtual screen a few feet above the surface of the moon with stars and planets in the sky all around. The video content item's environment parameters may specify everything about such an environment, e.g., the entire virtual appearance of the environment and any changes that may occur within the environment over the course of presentation of the video content item within the environment.

In some implementations, a video content item specifies a static viewing environment, e.g., consistent for an entire video or an entire particular scene of the video. In some implementations, a video content item specifies a dynamic viewing environment, e.g., that may change over time to show virtual objects moving, stars twinkling, lighting brightening or darkening, etc. In some implementations, a content creator (e.g., a producer of a series of superhero movies) creates a branded viewing environment that is generally consistent (although potentially with some variations) across multiple related video content items (e.g., used for both movies focused on super hero A and movies focused on super hero B, etc).

In some implementations, environment parameters specify effects that are dependent upon conditions (e.g., the environment's characteristics or the user's characteristics). For example, the parameters may specify different effects for relatively brighter viewing environments (e.g., above a threshold amount of average brightness) than for darker viewing environments (e.g., below the threshold amount of average brightness). In another example, the parameters may specify different effects when the user is laying on a sofa versus sitting at a desk.

In some implementations, the environment parameter data is obtained and used to present the video content item in real-time during streaming of the video content items, where the plurality of time segments are received sequentially and presented as each of the plurality of time segments is received.

Some implementations provide environmental lighting effects in non-XR circumstances. For example, a user may view content in a physical environment on a traditional television device. The environment lighting effects may be provided by additional devices in that physical environment, e.g., by lighting/LED strips along the wall, that provide such effects based on the environment lighting effects that are specified for the video content items being viewed on a content viewing device such as a television.

In the context of XR implementations, the lighting effects, e.g., light-spill effects, may be presented by controlling blend circuitry to generate XR video by: blending pass-through video with the video content item; and modifying at least a portion of the pass-through video based on the environment parameter data. Blending may involve the use of a blend circuitry (e.g., hardware blend architecture) comprising a dedicated pathway to at least one camera) pass-through video of a physical environment via at least one camera of the device. The blend circuitry may generate an XR video by blending the pass-through video with the video content item and by modifying at least one portion of the pass-through video with parameter-specified effects. The blend circuitry may blend an image corresponding to a current pass-through video frame with an image (from a corresponding viewpoint) of a video content item positioned within a 3D coordinate system corresponding to the physical environment. For example, the images may be combined using a technique that forms a combined frame using some pixel values (e.g., certain pixel positions) from the pass-through video frame and some pixel values (e.g., certain pixel positions) from the video content item frame. In one example, the blending utilizes alpha/transparency values, e.g., in pixel positions at which the pass-through video frame pixel is to be used, that pass-through pixel's values is set to not-transparent and the corresponding video content item frame pixel's value is set to fully transparent and, conversely, in pixel positions at which the video content item frame pixel is to be used, that pixel's values is set to fully-transparent and the corresponding video content item frame pixel (which may be empty) is set to not transparent. The pass-through video may be a still image (e.g., a single repeated frame) or may comprises a plurality of different (non-identical) frames.

In some implementations, altering the portion of each of the frames of the pass-through video to provide the lighting effect includes tinting, dimming, or changing a brightness of the respective portion of each of the frames.

In some implementations, altering the portion of each of the frames of the pass-through video to provide the light-spill effect includes performing a hardware-implemented logic operation via the blend circuitry.

In some implementations, altering the portion of each of the frames of the pass-through video to provide the light-spill effect includes utilizing the blend circuitry to apply a tinting, dimming, or brightness adjustment of the portion.

In some implementations, combining each of the frames of the pass-through video with the frame-specific video content includes utilizing the blend circuitry to enable a hardware-based alpha blending process. In some implementations, combining each of the frames of the pass-through video with the frame-specific video content includes adjusting alpha-blend values corresponding to the pass-through video in areas corresponding to the virtual light producing object. In some implementations, the augmented pass-through video has a frame rate greater than 60 fps. (e.g., 90 fps).

In some implementations, XR views/video is provided in approximately real time with the capturing of the pass-through video. For example, less than one frame delay between image capture and display, less than 11 ms at 90 fps, etc.

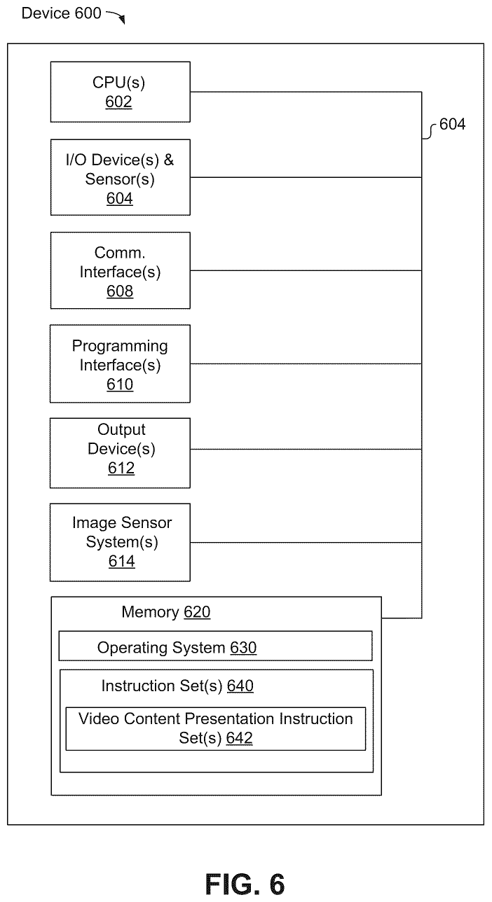

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUS, CPUs, processing cores, and/or the like), one or more input/output (I/O) devices and sensors 604, one or more communication interfaces 608 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 612 are configured to present a view of a physical environment, a graphical environment, an extended reality environment, etc. to the user. In some implementations, the one or more displays 612 are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 612 correspond to diffractive, reflective, polarized, holographic, etc. waveguide displays. In one example, the device 600 includes a single display. In another example, the device 600 includes a display for each eye of the user.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a video content presentation instruction set 642. The instruction set(s) 640 may be embodied as a single software executable or multiple software executables. The video content presentation instruction set 642 is configured with instructions executable by a processor to obtain and present video content items and to provide environment effects as described herein.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having at least one processor:
obtaining environment parameter data associated with a video content item, wherein the environmental parameter data is obtained from a source, wherein the source stores the environment parameter data for access to control presentation of playback environments during multiple playback instances of the video content item;
determining environment lighting effects corresponding to a plurality of time segments of the video content item, the environment lighting effects determined based on the environment parameter data; and
presenting the video content item in a viewing environment, wherein the viewing environment is modified based on the environment lighting effects in synchronization with presentation of the plurality of time segments of the video content item.

2. The method of claim 1, wherein the source is a file containing the video content item, wherein the file comprises a video track, an audio track, and an environment parameter track.

3. The method of claim 1, wherein the source is a database, wherein the environment parameter data associated with the video content item is obtained by obtaining one or more records from the database using a unique identifier associated with the video content item.

4. The method of claim 1, wherein presenting the video content item comprises presenting the video content item within a view of an extended reality (XR) environment, wherein the video content item is presented at a 3D position within the XR environment and the environment lighting effects alter the appearance of content in the view separate from the video content item.

5. The method of claim 1, wherein the environment parameter data comprises data for synchronizing the environment lighting effects with the plurality of time segments.

6. The method of claim 1, wherein the environment lighting effects comprise tint, dimming, or glow effects applied to at least a portion of the viewing environment.

7. The method of claim 1, wherein the environment lighting effects comprise light-spill effects and the environment parameter data specifies attributes of the light-spill effects.

8. The method of claim 7, wherein the environment parameter data specifies spatial display attribute of the light-spill effects relative to a position at which the video content item is displayed in a view.

9. The method of claim 7, wherein the environment parameter data specifies color, intensity, saturation, brightness, or opacity associated with the light-spill effects.

10. The method of claim 7, where the light-spill effects are presented by controlling blend circuitry to generate an extended reality (XR) video by:
blending pass-through video with the video content item; and
modifying at least a portion of the pass-through video based on the environment parameter data.

11. The method of claim 1, wherein the environment parameter data is generated based on input provided by a creator or editor of the video content item.

12. The method of claim 1, wherein the environment parameter data is obtained and used to present the video content item in real-time during streaming of the video content items, wherein the plurality of time segments are received sequentially and presented as each of the plurality of time segments is received.

13. The method of claim 1, wherein the video content item is presented in the viewing environment on a head-mounted device (HMD).

14. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining environment parameter data associated with a video content item, wherein the environmental parameter data is obtained from a source, wherein the source stores the environment parameter data for access to control presentation of playback environments during multiple playback instances of the video content item;
determining environment lighting effects corresponding to a plurality of time segments of the video content item, the environment lighting effects determined based on the environment parameter data; and
presenting the video content item in a viewing environment, wherein the viewing environment is modified based on the environment lighting effects in synchronization with presentation of the plurality of time segments of the video content item.

15. The system of claim 14, wherein the source is a file containing the video content item, wherein the file comprises a video track, an audio track, and an environment parameter track.

16. The system of claim 14, wherein the source is a database, wherein the environment parameter data associated with the video content item is obtained by obtaining one or more records from the database using a unique identifier associated with the video content item.

17. The system of claim 14, wherein presenting the video content item comprises presenting the video content item within a view of an extended reality (XR) environment, wherein the video content item is presented at a 3D position within the XR environment and the environment lighting effects alter the appearance of content in the view separate from the video content item.

18. The system of claim 14, wherein the environment parameter data comprises data for synchronizing the environment lighting effects with the plurality of time segments.

19. The system of claim 14, wherein the environment lighting effects comprise tint, dimming, or glow effects applied to at least a portion of the viewing environment.

20. A non-transitory computer-readable storage medium storing program instructions executable via one or more processors, of a device having at least one camera, a display, and blend circuitry, to perform the operations comprising:
obtaining environment parameter data associated with a video content item, wherein the environmental parameter data is obtained from a source, wherein the source stores the environment parameter data for access to control presentation of playback environments during multiple playback instances of the video content item;
determining environment lighting effects corresponding to a plurality of time segments of the video content item, the environment lighting effects determined based on the environment parameter data; and
presenting the video content item in a viewing environment, wherein the viewing environment is modified based on the environment lighting effects in synchronization with presentation of the plurality of time segments of the video content item.
